(19) United States
(12) Patent Application Publication
(10) Pub. No.: US 2017/0132177 A1
(43) Pub. Date: May 11, 2017

(54) System And Method For Rhythmic And Polyrhythmic Pattern Search And Publishing, And Flattening Engine That Receives And Analyzes To Be- Published Content

(71) Applicants: Dan Tocchini, San Francisco, CA (US); Henri Bergius, Berlin (DE)

(72) Inventors: Dan Tocchini, San Francisco, CA (US); Henri Bergius, Berlin (DE)

(21) Appl. No.: 15/163,651

(22) Filed: May 24, 2016

Related U.S. Application Data
(60) Provisional application No. 62/165,960, filed on May 24, 2015.

(51) Int. Cl. G06F 17/21; G06F 17/27; G06F 17/24

(52) U.S. Cl. CPC G06F 17/212; G06F 17/248; G06F 17/2765

(57) ABSTRACT

The present invention provides systems and methods that automates the presentation of e-content in a high quality, magazine-like manner, and are customizable to the taste of individual users and/or the audience.

### INCORPORATION BY REFERENCE

This application claims the benefit of priority under 35 U.S.C. 119(e) to the filing date of U.S. provisional patent application No. 62/165,960 “System And Method For Rhythmic And Polyrhythmic Pattern Search And Publishing, And Flattening Engine That Receives And Analyzes To Be-Published Content” which was filed on May 24, 2015, and which are incorporated herein by reference in their entirety.

### FIELD OF INVENTION

The present invention is directed generally to a system and method for consuming and presenting digital content. In particular, the system and method may be used for consuming and presenting digital content such as a blog on computers, tablets, cellular phones, etc.

### BACKGROUND OF THE INVENTION

The present invention relates to systems and methods for presenting electronic content (e-content) with a high quality magazine-like presentation, which can be tailored to the taste of individual users and/or the audience.

Since the existence of the Internet, publishing content has been made easier by the widespread availability of Internet connections and advent of software. However, because of the limitation of web technologies, an attractive presentation of the content is traded off for ease of the flow of the e-content. For examples, network bandwidth limitation favors texts over images, and the lack of sophisticated and advanced e-content publishing software forces web publishers to plainly stack pieces of the content one on another. To overcome this plain look, web publishers currently have to layout the content manually similar to laying out a print magazine. Without a doubt, this process is time consuming and inhibits e-content dissemination from being instantaneous.

For example, FIG. 1 illustrates the current stacking layout of a web page. As it is shown, the owner's photo is not clear because it is a distance shot and the photo background is unnecessary. All texts on the blog have same font and font size, so the audience does not know what message is important. Thumbnail images of different sizes are placed everywhere, disorganized and random, so much so that they make the blog look unpleasing to the eye.

To compound the problem, publishers provide an increasing amount of content items to users through digital distribution channels, and users access these content items through various client devices. However, different client devices have different capabilities for displaying content items. For example, different client devices have different display areas, different display resolutions, different content download speeds, and different processing capabilities. These variations in display capabilities make it difficult for publishers to present content items on different client devices in a consistent manner.

For example, if a publisher of a digital magazine seeks to display a table of contents for a digital magazine or for a section of the digital magazine, the number of content items displayed by the table of contents may vary based on the client device. This variation in displayed content items may be based on variations in display resolutions or display areas of different client devices. The wide variety of client devices used to present content items makes use of device-specific display algorithms impractical. Some conventional techniques for displaying a table of contents shrink the display size of each content item to display all content items in a display area or exclude some content items from display. However, these techniques limit the ability of a user to view a comprehensive listing of the content items in a digital magazine or a section of the digital magazine.

The proliferation of lightweight, portable computing devices with various screen sizes has lead to a high demand for software applications that can displayed in either landscape or portrait orientations, depending on a user's viewing preference. Because switching a handheld computing device, such as a smartphone or a tablet computer, between landscape and portrait orientations involves simply adjusting how the device is being held, the user may choose to switch back and forth between orientations at will.

The poor quality of the layout of web content on portable computing devices stems in part from the challenges associated with translating web content designed to be viewed on one display device to one or more different display devices. Each display device may have different dimensions and resolution. An article from a publisher may contain, for example, a title, subtitle, by-line, dateline, text, pull-quotes, images, and captions, which are collectively referred to as the assets of the article. To accommodate the variety of assets of an article, a sophisticated layout may be required. However, such a sophisticated layout may not translate well between display devices having different dimensions and resolution. Such a sophisticated layout has previously also been time consuming to create, since the articles had typically needed to be laid out manually by the publisher.

To design an audience-winning layout, web publishers must pay attention to the rhythm of the design elements of the layout. Rhythm is a recurring pattern of elements, such as lines, forms, logos, images, fonts, font sizes, line spacing, tiles, size of tiles, element spacing, colors, that create a sense of direction or a sense of movement. In layout, the goal is to create a “harmonious whole”. The eye should not be distracted by disorganized, randomly placed elements, but should be led through the composition. Furthermore, the rhythms could go horizontal or vertical or both. By the repetitive use of an element to create a pattern within a given composition, these elements serve to unify the work into a sound composition. Therefore, mastering the uses of horizontal and vertical rhythms is the key to a winning layout.

Recently, web publishers have taken a step further by applying polyrhythmic designs to layouts. Polyrhythmic design is the simultaneous use of two or more conflicting rhythms that are not readily perceived as derivatives of one another to highlight the main rhythm. This method is used widely in drama, where protagonists overcomes antagonists, and music, where main rhythms are intertwined with a cross-beat rhythm to express a conflict/challenge.

Despite the sophistication of design techniques, the current publishing software systems treat the input HTML or XML content as a black box; that is, the publishing systems provide a container to house the content, but do not analyze the content for an optimal and rhythmic layout. The end result is that the content is displayed disconnected with other content on the web page in either a vertical section of the web page or a tile. The vertical sections stack on top of each other in some order. The tiles are a marginal improvement over the vertical stack by utilizing the horizontal sections of the web page. However, rows of tiles are still stacked on top of each other. Each of the containers, vertical section or tile, has a different layout accompanying the source content. It is inevitable that two adjacent containers would have contrasting layouts, and would negatively affect the overall aesthetics of the web page.

Thus, it is desirable to have both the ease of publishing e-content, and a high quality, magazine-like, and customized presentation of the content, given that the Internet bandwidth has been improved so much that images are displayed as equally efficient as texts. That is, desirable systems and methods of presenting e-content would automatically analyze a content, which comprises texts, images, and media clips, and present the content in an appealing, high quality, and magazine-like manner tailored to individual users and audiences' taste.

### OBJECTIVE OF THE INVENTION

Accordingly, it is the object of this invention to provide a system and method rhythmic and polyrhythmic pattern search and publishing content in a high quality, magazine-like manner.

It is also the object of this invention to provide a system and methods wherein the published content is in one or more rhythms that hold the designs together such that the design elements do not contradict or distract form one another.

It is also the object of this invention to provide systems and methods of automatic electronic content publishing that is customizable to individual users' and audiences' taste.

It is also the object of this invention to provide systems and methods of automatic electronic content publishing that comprises texts, images, and media clips.

It is also the object of this invention to provide systems and methods of automatic electronic content publishing that provides for a content flattening engine that receives and analyzes to be-published content.

It is also the object of this invention for the content flattening engine to dissect the content into units of texts, images, and/or media clips while maintaining properties such as number of works, font type, image size and resolution, image aspect ratio, image orientation, media clip size and type, video blocks, etc.

It is also the object of this invention for the content flattening engine to employ a plurality of techniques, including but not limited to parsing the incoming content stream.

It is also the object of this invention to provide systems and methods of automatic electronic content publishing that provides for an enrichment engine that enriches the elements of the content.

It is also the object of this invention for the enrichment engine to reformat texts as to font, color, styles, and/or to reflow texts to fit harmoniously with the whole layout.

It is also the object of this invention for the enrichment engine to analyze, crop, resize, and/or modify resolution of images to increase their aesthetic and that of the whole layout.

It is also the object of this invention for the enrichment engine to splice, cut, and/or downscale media clips to fit the other content elements and boost the displaying performance of the web page.

It is also the object of this invention for the enrichment engine to track and update the metadata to reflect the changes being made.

It is also the object of this invention to provide systems and methods of automatic electronic content publishing that provides for a layout engine that pair the incoming content with an optimal layout in a large repository of layout templates.

It is also the object of this invention for the layout engine to use the content's metadata, which set forth the parameter for search, to pair the incoming content with the optimal layout

It is also the object of this invention for the layout engine to provide a pathfinding algorithm to efficiently search through the template repository for an optimal layout.

It is also the object of this invention for the layout engine to employ the use of heuristics based on the knowledge of templates in the repository and/or the users' predefined rules.

It is also the object of this invention for the layout engine to build up a weighted heuristic engine capable of automatically selecting an optimal layout based on the user's taste and experience.

It is also the object of this invention to provide systems and methods of automatic electronic content publishing that provides for a presentation engine that receives and inputs content and the selected template.

It is also the object of this invention for the presentation engine to place content elements in the designated positions of the selected layout template, relying on the composed metadata.

It is also the object of this invention to provide systems and methods of automatic electronic content publishing to provide for a user friendly interface to aid web publishers and designers in designing layout templates and saving them to the repository.

It is also the object of this invention to provide systems and methods of automatic electronic content publishing to provide for a user friendly interface to aid users in managing the layout repository and categorizing the layout templates.

It is also the object of this invention to provide systems and methods of automatic electronic content publishing to decouple the design aspect and the technology aspect of web publishing in order to open up new opportunity for a marketplace of third party designers' layout templates.

It is also the object of this invention to provide systems and methods to automatically determine the preexisting rhythmic and polyrhythmic harmony of electronic content to be published.

It is further the object of this invention to provide systems and methods to automatically assign pre-computed layouts pending a satisfactory degree of preexisting harmony inherent within the content, thereby, conserving computational resources.

It is also the object of this invention to provide a system and methods to automatically assign at least one optimal layout in the event numerous equally optimal layouts result from content processing, thereby, ensuring content will be published consistently without failure.

### SUMMARY OF THE INVENTION

In one aspect of the invention, a computer-implemented system, comprising: a content flattening engine, which in operation, accepts a plurality of content from a dynamically aggregated feed of content or from an user input; parses and dissects the content into units of text and or media file and recording a plurality of attributes and properties of the units; categorizes the units based on the attributes and the properties; a content enrichment engine, which in operation, enriches the units according to the attributes and the properties by reformatting and resizing the units into a plurality of processed units for optimization of harmonious fitment and displaying performance of a layout; a layout engine, which in operation, accepts the processed units and matching the processed units to the layout wherein the layout is selected from a repository of layout templates; a presentation engine, which in operation, integrates the processed units into a designated position of the layout; requests the enrichment engine to further reformat the processed units in order to snug fit the processed units into the layout resulting a final ready layout; presents the final ready layout.

In one embodiment, the layout engine assigns a preference score of a selected layout to a heuristics database in order to subsequently recommend a preferred layout to a user.

In one embodiment, the final ready layout contains a rhythmic or polyrhythmic pattern.

In one embodiment, the content is comprised of texts, images, videos, and audio feeds.

In one embodiment, the content is dynamically aggregated from a content source comprising web pages, web feeds and social network platforms.

In one embodiment, the attribute is selected from a group consisted of number of words, font type, font size, image size, image resolution, image aspect ratio, image orientation, media clip type, video blocks, media clip size, media type, size of an object in an image, position of an object in an image, content of an objection in an image.

In one embodiment, the properties are metadata.

In one embodiment, wherein the enrichment process is comprised of reformatting color of a text, reformatting style of a text, reformatting font of a text, reformatting size of a text, reformatting size of an image, reformatting resolution of an image, reformatting borders of an image, reformatting zoom of an image, reformatting resolution of a media clip, reformatting length of a media clip, reformatting size of a media clip.

In one embodiment, the properties and attributes of the processed unit are updated to be consistent with the enrichment process.

In one embodiment, the metadata of the processed unit are updated to be consistent with the enrichment process.

In one embodiment, the layout engine uses an algorithm to match the processed units to the layout wherein the layout is selected from a repository of layout templates. In one embodiment, the algorithm enables the final layout to contain a rhythmic or a polyrhythmic pattern. In one embodiment, the algorithm enables the final layout to contain a harmonious tiling pattern.

In one embodiment, the final ready layout is an arbitrary, well-formed, HTML file.

In another aspect of the invention, a method comprising accepting a plurality of content from dynamically aggregated feed of content or an user input; parsing and dissecting the content into units of text and or media file and recording a plurality of attributes and properties of the unit; categorizing the units based on the attributes and the properties; enriching the units according to the attributes and the properties by reformatting and resizing the units into a plurality of processed units for optimization of harmonious fitment and displaying performance of a layout; accepting the processed units and matching the processed units to the layout wherein the layout is selected from a repository of layout templates; integrating the processed units into a designated position of the layout; requesting the enrichment engine to further reformat the processed units in order to snug fit the processed units into the layout resulting a final ready layout; presenting the final ready layout.

In one embodiment, further comprising assigning a preference score of a selected layout to a heuristics database in order to recommend a preferred layout to a user.

In one embodiment, the final ready layout contains a rhythmic or polyrhythmic pattern.

In one embodiment, the content is comprised of texts, images, videos, and audio feeds.

In one embodiment, the content is dynamically aggregated from a content source comprising web pages, web feeds and social network platforms.

In one embodiment, the attribute is selected from a group consisted of number of words, font type, font size, image size, image resolution, image aspect ratio, image orientation, media clip type, video blocks, media clip size, media type, size of an object in an image, position of an object in an image, content of an objection in an image.

In one embodiment, the properties are metadata.

In one embodiment, the enrichment process is comprised of reformatting color of a text, reformatting style of a text, reformatting font of a text, reformatting size of a text, reformatting size of an image, reformatting resolution of an image, reformatting borders of an image, reformatting zoom of an image, reformatting resolution of a media clip, reformatting length of a media clip, reformatting size of a media clip.

In one embodiment, the properties and attributes of the processed unit are updated to be consistent with the enrichment process. In one embodiment, the metadata of the processed unit are updated consistent with the enrichment process.

In one embodiment, the layout engine uses an algorithm to match the processed unit to the layout wherein the layout is selected from a repository of layout templates. In one embodiment, the algorithm enables the final layout to contain a rhythmic or a polyrhythmic pattern. In one embodiment, the algorithm enables the final layout to contain a harmonious tiling pattern.

In one embodiment, the algorithm enables the final layout to contain a harmonious tiling pattern.

In one embodiment, the final ready layout is an arbitrary, well-formed, HTML file.

### BRIEF DESCRIPTIONS OF THE DRAWINGS

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 illustrates an example of the current tiling and stacking method of displaying e-content.

FIG. 2 illustrates an example of the current invention's method of displaying e-content in a rhythmic manner.

FIG. 3 illustrates a high-level block diagram of a system environment for generating e-content using the current invention's polyrhythmic method of content presentation.

FIG. 4 illustrates a block diagram of the content processing system for generating e-content using the current invention's polyrhythmic method of content presentation.

FIG. 5 illustrates a block diagram of the content flattening engine of the current invention for generating e-content using the current invention's polyrhythmic method of content presentation.

FIG. 6 illustrates a block diagram of the enrichment engine of the current invention for generating e-content using the current invention's polyrhythmic method of content presentation.

FIG. 7 illustrates a block diagram of the layout engine of the current invention for generating e-content using the current invention's polyrhythmic method of content presentation.

FIG. 8 illustrates a block diagram of the presentation engine of the current invention for generating e-content using the current invention's polyrhythmic method of content presentation.

FIG. 9 illustrates an example of the current invention performing image feature detection to provide optimal aspect ratio, scale, and crop.

FIG. 10 illustrates an example of the image as in FIG. 9 that is over scaled using traditional method of fitting an image to a frame.

FIG. 11 illustrates an example of the image as in FIG. 9 that is over cropped using traditional method of fitting an image to a frame.

FIG. 12 illustrates an example of the image as in FIG. 9 that has been optimally scaled and cropped using the current invention of displaying e-content.

FIG. 13 illustrates an example of a screen shot of a video as presented using the current tiling and stacking method of displaying e-content.

FIG. 14 illustrates an example of a screen shot of the video as in FIG. 13 optimally scaled and cropped using the current invention of displaying e-content.

FIG. 15 illustrates an example of displaying multiple images and text as presented using the current tiling and stacking method of displaying e-content.

FIG. 16 illustrates an example of displaying the multiple images and texts as in FIG. 15 using the current invention of displaying e-content.

FIG. 17(A), a partial view and top half of FIG. 17, which illustrates a preferred embodiment of the present flattening engine that receives and analyzes to be-published content.

FIG. 17(B), a partial view and bottom half of FIG. 17, which illustrates a preferred embodiment of the present flattening engine that receives and analyzes to be-published content.

FIG. 18 illustrates a block diagram of the present pre-computed layout module that receives and analyzes content for inherent harmony by using declarative, constrained-based language for composing polyrhythmic fitness functions over arbitrary data sets.

FIG. 19 illustrates an example of a pre-computed layout module assigning content, with inherent harmony, a pre-computed template thus preserving computational resources.

FIG. 20 illustrates a preferred embodiment of the present solution pathway module that receives and analyzes user configuration as well as GOM metadata from “Poly” to form a solution path to be utilized by the design system.

FIG. 21 illustrates an embodiment of a design system utilizing multiple solution pathway modules to produce a solution tree and consequently an HTML rendered page.

### DETAILED DESCRIPTION OF THE INVENTION

The following detailed description refers to the accompanying drawings that illustrate certain embodiments consistent with this invention. Other embodiments are possible, and modifications can be made to the embodiments within the spirit and scope of the invention. Therefore, the detailed description is not meant to limit the invention; rather, it is meant to illustrate by example. It should be noted that references to “an” or “one” or “some” embodiment(s) in this disclosure are not necessarily to the same embodiment, and such references mean at least one.

A new approach is proposed that contemplates systems and methods to provide an automatic, yet customizable to individual users and audiences' taste, publishing e-content, which comprises texts, images, and media clips, in a high quality, magazine-like manner. The approach addresses the issue of design and technology know-how through separating or decoupling of the design aspect and the technology aspect. Specifically, the approach automatically provides the most optimum layout or presentation to be selected over time based on heuristics, which relies on metadata.

Generally, one of the first rhythms that viewers confront in a design is the rhythm of the format. The format has a dominant and a subordinate rhythm. The dominant rhythm is determined by the longest axis. Another rhythm is the rhythm of words and groups of words wherein the word shapes are adaptable and work well with each other. They also need to be balance and have clarity of each part within a composition. There may also be other types of rhythms and these one or more rhythms, or polyrhythms, should compliment one another and not draw undue attention to itself or others. Therefore, it is important to understand the content available to be composed in the design. As such, a content flattening component, or a content flattening engine, is necessary to first analyze and structure the contents.

In one embodiment, a content flattening engine is provided to receive and analyze the to be-published content from a variety of sources. Each content item comprises one or more units. Each unit has a unit type, such as text, image, or video. The units included in each received item are identified by the content flattening engine and stored with the item. Then, this engine dissects the content into units of texts, images, and/or media clips while keeping notes of their properties, such as the number of words, font type, image size and resolution, image aspect ratio, image orientation (i.e., landscape or portrait), media clip size and type, video blocks, etc. This property information can be very detailed and sophisticated, and can include information such as the size and position of objects in an image, e.g., persons' faces, objects, background, etc.

This engine employs a plurality of techniques, including parsing the incoming content stream, in order to categorize the units based on their properties. For example, well known HTML and/or XML tags are detected and parsed. These tags are metadata that are an important part of the collected property information that are later used in selecting templates.

Besides providing intelligent information about the content elements, they also provides the structure of the content; in other words, information about how elements relate to one another. A plurality of algorithms for analyzing binary streams of texts, images, and videos are employed, and the objects' properties are collected. The collected property information, or metadata, is fed into subsequent engines to prepare for an optimal layout of the content. The content flattening component allows the contents to be sorted and structured such that the rhythm or rhythms of the design based on the contents can be determined. However, when the contents in their native state cannot provide a natural rhythm, the contents can be altered or modify in order to improve the overall flow of the design, and this is done through the enrichment component.

In one embodiment, an enrichment engine is provided to enrich the elements of the content. The incoming content is a binary stream that is accompanied by the metadata, which provides the structure of the content and each elements' relevant properties. For example texts are reformatted as to font, color, styles, and/or reflowed to fit harmoniously with the whole layout. Images are analyzed, cropped or resized, and/or modified resolution-wise to increase its own aesthetic and that of the whole layout. Media clips are spliced, cut, downscaled, etc. to fit the other content elements and boost the displaying performance of the web page.

While enriching the content, the changes in the properties of the content elements are tracked and the metadata is updated to reflect the changes. The output of this engine and its method is a desired content stream, and it is the metadata the contents that enable the method and system to be able to generate a high quality, magazine-like layout. Once the contents have been enriched, they need to be arranged in such a way as to provide a rhythmic or poly rhythmic layout, and this is done through the layout component.

In one embodiment, a layout engine is provided to pair the incoming content with an optimal layout in a large repository of layout templates. More particularly, the layout engine uses content's metadata to pair the incoming content with an optimal layout. Specifically, the metadata, which are composed by the flattening engines, sets the criteria or parameters for the search. Then, a pathfinding algorithm is employed to efficiently search through the template repository for an optimal layout that best represents the content. The pathfinding algorithm uses the criteria or parameter set forth by the metadata in order to efficiently search through the template repository for the optimal layout.

One way to improve the efficiency of the search is to perform the search with the use of heuristics, which are experience-based techniques for problem solving, learning, and discovery. In more precise terms, heuristics are strategies using readily accessible and applicable information to control problem solving. In this case, the heuristics employed are based on the knowledge of templates in the repository and/or the users' predefined rules. Notably, this layout engine allows and works best with specific rules.

Furthermore, when the search result is a set or range, the result is presented to the user for whom to pick the favorite template according to the user's taste, and personal and professional experience with the content. This engine would remember the user's selection, and assigns it a higher preference score. Overtime, this layout engine builds up a weighted heuristic engine capable of automatically selecting an optimal layout with preference to the users' taste for a given content.

In addition to a good weighted heuristic engine, a quality large repository of layout templates makes up the quality of the present publishing system. Clearly, the larger repository of different layout templates is, the more quality the outcome of the present publishing system. The different layout templates could accommodate any possible content there is.

The repository of layout templates is also an innovative way to incorporate custom, taste preference design elements into an automated publishing system. Using the present system, web publishers and designers are free to focus on the design aspect of web publishing without worrying about how to fit their designs to the web technologies. In one embodiment, a user-friendly interface is provided to aid web publishers and designers in designing layout templates and saving them to the repository.

In another embodiment, instead of approaching the repository with a one-dimensional approach, the system can search through the repository via artificial intelligence engine. More specifically, the current approach to the search of repository requires assigning various values to criteria, and the system selects the best templates base on the criteria with the highest values. This process is slow, requires large amount of interaction, and is resource intensive. The alternative is to use artificial intelligence (AI) engine that labels the decision tree to discern the most likely to be picked layout through predictive behavior prediction or predictive analytic. For example, instead of using nodes with assigned values to make decisions, the AI engine can generate sets of rules depending on the user input to select the most likely layout. In other words, the AI engine does not need to assign and calculate each node value at every step. Instead, the AI engine is able to use the given criteria and, based on past user behavior, predicts and selects the best rules. The AI engine, then, make subsequent decisions base on those prediction rules to determine the best layout.

This friendly interface also aids users in managing the layout repository and categorizing the layout templates. Based on certain predefined criteria, similar templates are put in a category. It is appreciated that a template could belong to more than one category. The layout engine in its search for an optimal layout would use the category properties, or metadata. Furthermore, layout templates within a category are often compared during the searching. Clearly, the more categories and detailed metadata are, the better quality the outcome layout is for a given input content.

Since the present invention decouples the design and technology aspect of web publishing, it opens up a new opportunity for a marketplace of third party designers' layout templates. The marketplace would provide incentives for ever better layouts and layout repositories, and drives down the cost of creating the layout templates. This in turn would allow web publishers to focus on the content.

Once the layout component pairs the incoming contents with the optimal template, the content and the template needs to interact in such a way as to make the content flow to provide a rhythmic or polyrhythmic pattern to hold the design together, and the presentation component allows the content and the template to interact and compose a rhythmic or polyrhythmic design.

In another embodiment, a presentation engine is provided to receive the input content and the selected template. This engine places the content elements in the designated positions of the selected layout template, relying on the metadata composed by previous engines. The enrichment engine may be called upon to further modify the content to “snug” fit the content elements to the final layout template.

Once the content elements are fitted in their positions on the layout, the whole web page is presented to the users for a final approval. It is appreciated that as the template repository grows larger, there will be more than one template to be a fit for the given content. The preview would become a chance for the users to pick the best presentation for a final approval. It is also appreciated that the users could translate their final selection criteria into rules that could be added to the heuristic engine, and used by the layout engine and its search engine to automate the selection process. The final presentation is a rhythmic or polyrhythmic design wherein the contents all flow together harmoniously.

### DETAILED DESCRIPTIONS OF THE DRAWINGS

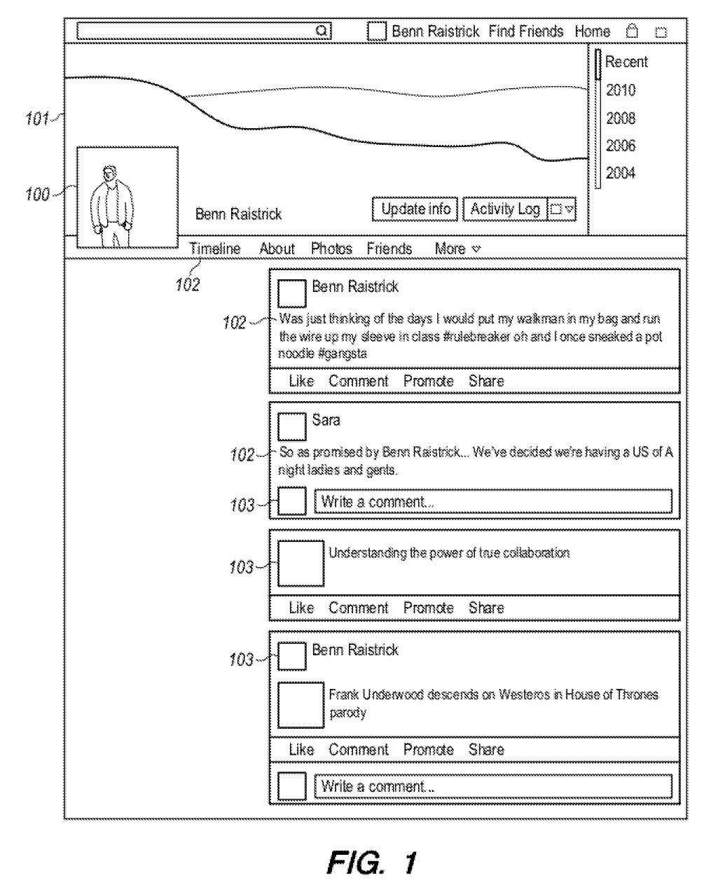

FIG. 1 illustrates the current stacking layout of a web page. As it is shown, there are a variety of issues and problems that needs to be addressed. First, the owner's photo 100 is not clear because it is a distance shot. Second, the photo background 101 is unnecessary, and it draws attention away from the main focus of the photo 100. Furthermore, all the texts 102 on the blog have same font style and font size; therefore, the audience does not know what message is important because nothing stands out in particular to the audience. Moreover, different size thumbnail images 103 are randomly placed, resulting in disorganization to the point that they make the blog look unpleasing to the eye.

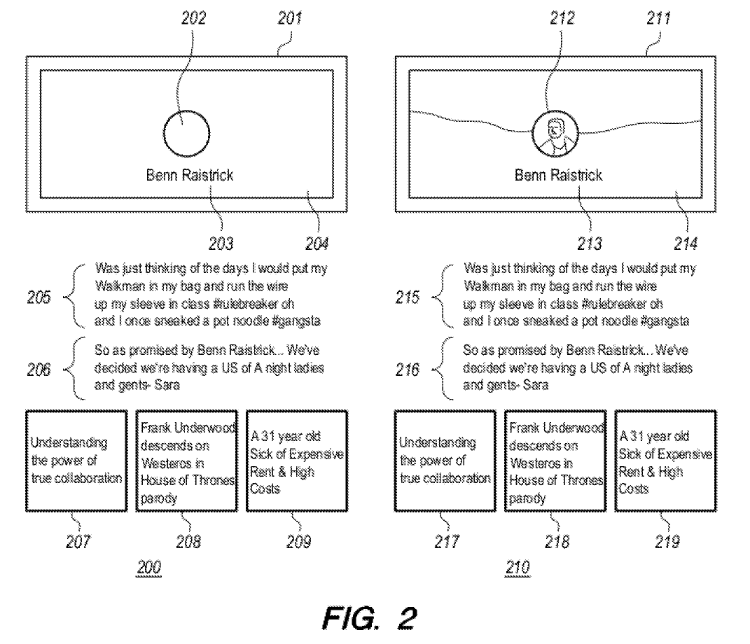

Referring to FIG. 2, in one embodiment, vertical and horizontal rhythmic designs are employed to produce a very appealing blog. The layout template 200 on the left employs many design elements. Vertically, the layout has a header block 201 where a circular image container 202 and text container 203 are placed inside another larger background image container 204. The image container 202 is for the headshot of the owner; text container 203 for his name; and background image 204 for his personality, mood, and/or inspiration. Below the header block is the quote of the day or the owner's thought of the day block 205. Large font makes the quote in important content element of the blog. Below quote is the miscellaneous message/announcement block 206, whose font is much smaller than the text above, and this visually informs the audience of an unimportant message. Finally, below the miscellaneous message block, three equal size tiles 207, 208, 209 are placed horizontally, and used to show the owner's favorite news articles. A horizontal rhythm is employed here where an image from each article is used for the background of the tiles, and each article's title is placed on top the image in the foreground, and has white font.

Still referring to FIG. 2, on the right side, an example of a final presentation of the blog layout 210 is presented. In the header block 211, the owner's headshot is cropped to fit the small circular image container 212. The text container 213 displays the owner's name, and a background image 214 displays an image for owner's personality, mood, and/or inspiration. The quote of the day block 215 is prominent displayed on the blog. Below the quote is the miscellaneous message/announcement block 216 that displays a message from the owner's friend. The white article titles 217, 218, 219 contrast well against the background image. As a whole, the blog 210 is pleasing to the eye.

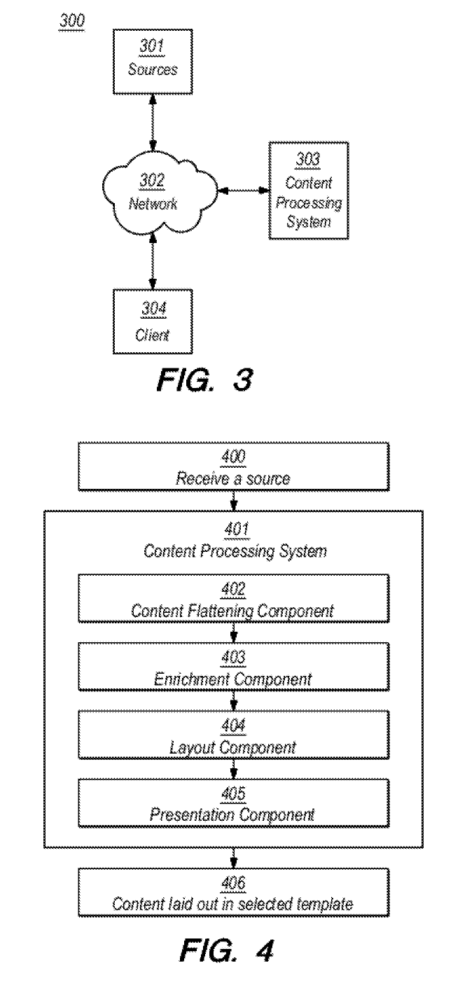

Referring to FIG. 3, the environment 300 includes content sources 301, a client 304, and a content processing system 303 in communication over a network 302. The sources 301 includes various types of content such as text, images, videos, or audio on web pages, web feeds, social networks, or other distribution platforms. The content may also include content provided by publishers, such as stories about news events, product information, entertainment, or educational material. Content may also include user-generated content such as blogs, tweets, shared images, video or audio, and social networking posts and status updates. For convenience, content from a source, regardless of its composition, may be referred to herein as “content unit” or simply “content.”

The content processing system 303 receives content items from the sources 301, processes the content items to build pages, and serves the pages to a client 304. On the other hand, a client 304 can be any computing device equipped with a browser for accessing web pages and a display for viewing them, such as a personal computer, a tablet computer, or a mobile device. A client 304 receives pages from the content processing system 303 and displays them to a user.

Referring to FIG. 4, a source 400 is sent to the content processing system 401. The content processing system 401 comprises a content flattening engine 402, an enrichment engine 403, a layout engine 404, and a presentation engine 405.

The content flattening engine 402 is provided to receive and analyze the to be-published content from a variety of sources. Besides providing intelligent information about the content elements, they also provides the structure of the content; in other words, information about how elements relate to one another.

The enrichment engine 403 is provided to enrich the elements of the content. While enriching the content, the changes in the properties of the content elements are tracked and the metadata is updated to reflect the changes. The output of this engine and its method is a desired content stream, and it is the metadata the contents that enable the method and system to be able to generate a high quality, magazine-like layout.

The layout engine 404 is provided to pair the incoming content with an optimal layout in a large repository of layout templates. More particularly, the layout engine uses content's metadata to pair the incoming content with an optimal layout.

The presentation engine 405 is provided to receive the input content and the selected template. This engine places the content elements in the designated positions of the selected layout template, relying on the metadata composed by previous engines.

Once the content elements are fitted in their positions on the layout, the whole web page is presented to the users for a final approval. The content is laid out in the selected template and the resulting e-content 406 is sent to the client.

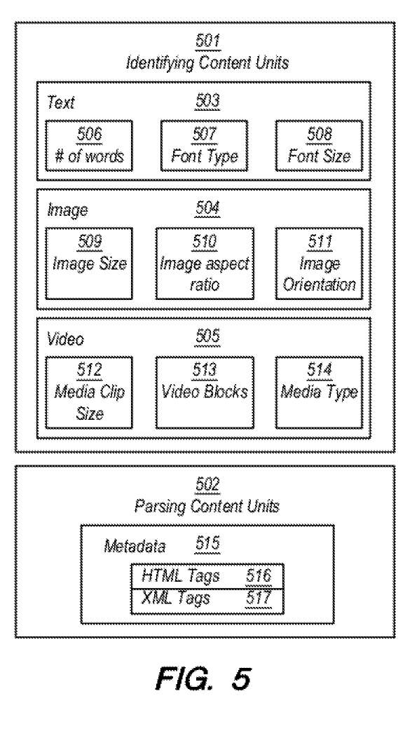

Referring to FIG. 5, the content flattening engine 500 processes the contents in two separate steps. The content flattening engine 500 identities the content units 501 and dissects the content into units of texts 503, images 504, and/or media clips 505 while keeping notes of their properties, such as the number of words 506, font type 507, font size 508 image size and resolution 509, image aspect ratio 510, image orientation 511 (i.e., landscape or portrait), media clip type 512, video blocks 513, media clip size 513, media type 514, size and position of objects in an image, e.g., persons' faces, objects, background, etc.

Then, the content flattening engine 500 parses the content units 502 in order to categorize the units based on their properties such as metadata 515. For example, well known HTML tag 516 and XML tags 517 are detected and parsed. These tags are metadata 515 that are an important part of the collected property information that are later used in selecting templates.

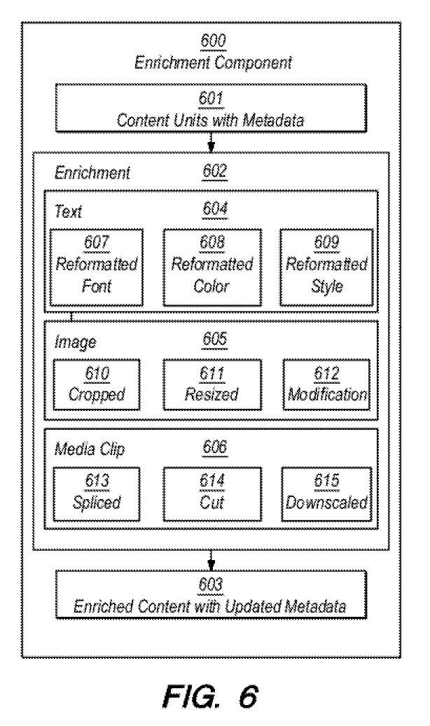

Referring to FIG. 6, the enrichment engine 600 enriches the elements of the content. The incoming content is a binary stream, and each binary stream or content units, is accompanied by the metadata 601, which provides the structure of the content and each elements' relevant properties.

The content unit with metadata 601 is enriched via the enrichment process 602 according to its metadata properties. For example, texts 604 are reformatted as to font 607, color 608, styles 609, and/or reflowed to fit harmoniously with the whole layout. Images 605 are analyzed, cropped 610 or resized 611, and/or modified resolution-wise 612 to increase its own aesthetic and that of the whole layout. Media clips 606 are spliced 613, cut 614, down-scaled 614, etc. to fit the other content elements and boost the displaying performance of the web page.

While enriching the content, the changes in the properties of the content elements are tracked and the metadata is updated 603 to reflect the changes. The output of this engine and its method is a desired content stream, and it is the metadata the contents that enable the method and system to be able to generate a high quality, magazine-like layout.

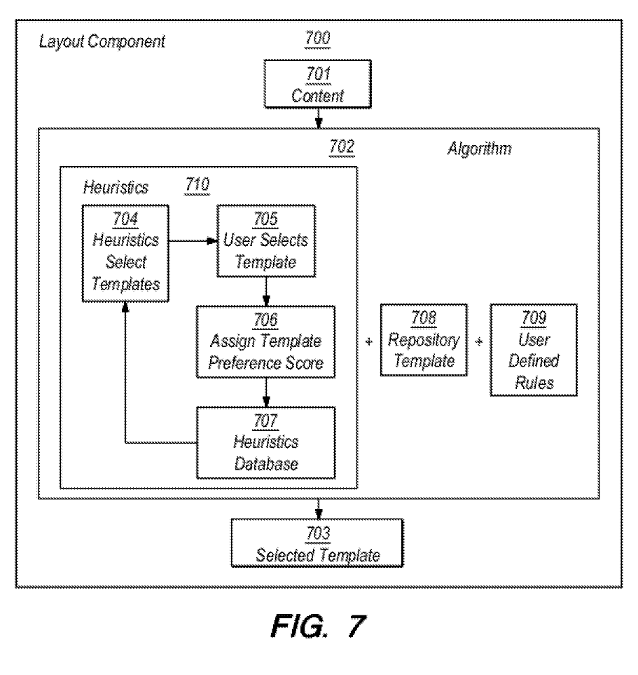

Referring to FIG. 7, the layout engine 700 provides to pair the incoming content 701 through an algorithm 702 with an optimal layout 703 in a large repository of layout templates.

Specifically, the algorithm 702 employs a heuristics 710 that select several templates 704 from which the user can further select the template 705. Then, the user selected template will be assigned a preference score 706 that is stored in the heuristics database 707 which will be used by the heuristics to improve its selection of templates 704. The Heuristics 710 in connection with the repository template 708 and the user defined rules 709 result in the optimal layout for the content 701 using the selected template 703.

Notably, a quality large repository 708 of layout templates makes up the quality of the present publishing system. Clearly, the larger repository of different layout templates is, the more quality the outcome of the present publishing system. The different layout templates could accommodate any possible content there is.

Furthermore, the user can define rules 709 to guide the selection of templates and allows the user to manage the layout templates through categories. The layout engine, in its search for an optimal layout, would use the category properties, or metadata. Moreover, layout templates within a category are often compared during the searching. As such, the more categories and detailed metadata are, the better quality the outcome layout is for a given input content.

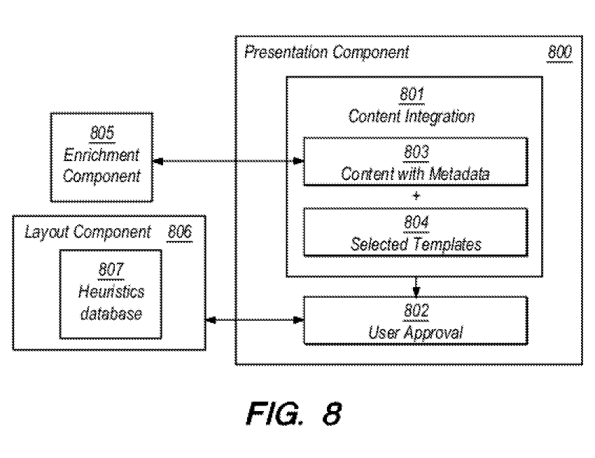

Referring to FIG. 8, the presentation engine 800 comprises a content integration step 801 and a user approval step 802. Specifically, the content integration 801 places the content 803 in the designated positions of the selected layout template 804, relying on the metadata composed by previous engines. The enrichment engine 805 may be called upon to further modify the content to “snug” fit the content elements to the final layout template.

Once the content elements are fitted in their positions on the layout, the whole web page is presented to the users for a final approval 802. Furthermore, as the template repository grows larger, the layout engine 806 will be able to provide increasing more templates for a given content. The preview would become a chance for the users to pick the best presentation for a final approval 802. Moreover, the users could translate their final selection criteria into rules that could be added to the heuristic engine 807, and used by the layout engine 806 and its search engine to automate the selection process.

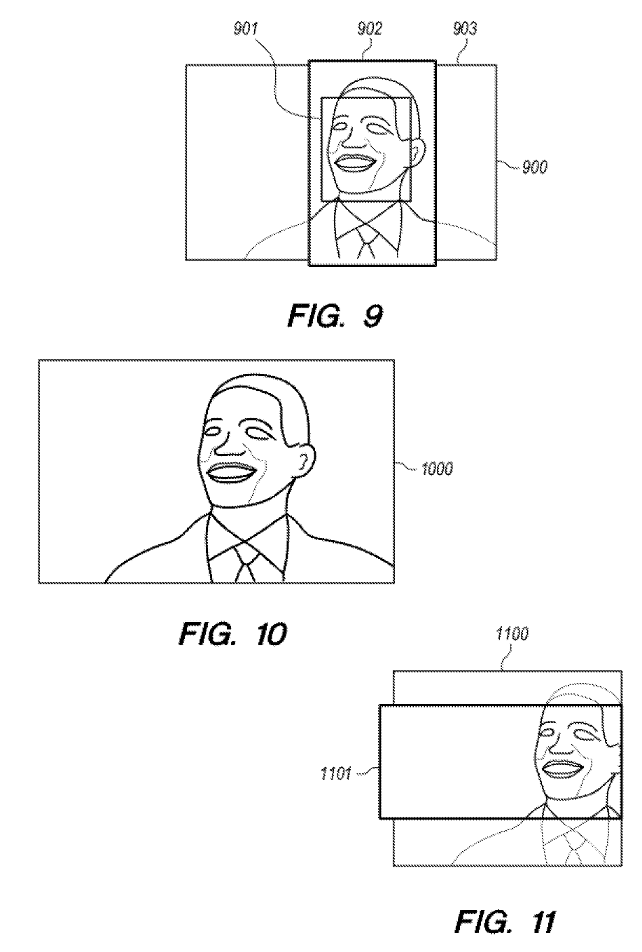

Referring to FIG. 9, this is an example of the current invention performing image feature detection to provide optimal aspect ratio, scale, and crop. Specifically, the image 900 is a photo of a person with a background. The current invention performs detection of important image features, such as faces 901, foreground subjects 902, and backgrounds 903. This allows the current invention to calculate and perform the optimal scaling and cropping of the image 900 in order for it to optimally fit the frames with minimal crop and up-sampled scaling.

Referring to FIG. 10, this is an example of the image as in FIG. 9 that is over scaled using traditional method of fitting an image to a frame. The image 1000 is over scaled, and, as a result, becomes distorted and pixelated.

Similarly, FIG. 11, this is an example of the image as in FIG. 9 that is over cropped using traditional method of fitting an image to a frame. The image 1100 is over cropped such that the resulting image 1101 has the cut of part of a person's face and the face is too much to the right causing an imbalance.

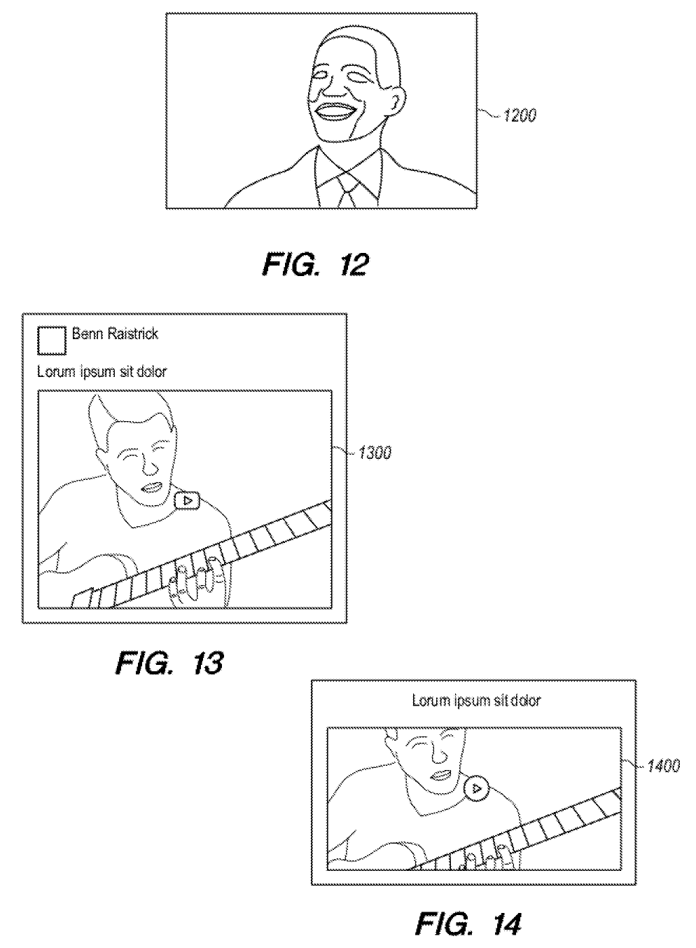

Referring to FIG. 12, on the other hand, this is an example of the image as in FIG. 9 that has been optimally scaled and cropped using the current invention of displaying e-content. The image 1200 has been processed using an image feature detection that has determined the face, the foreground, and the background of the image. Then, based on those features, the image 1200 has been optimally and minimally cropped and scaled to allow it to fit the frame perfectly.

Referring to FIG. 13, this is an example of a screen shot of a video as presented using the current tiling and stacking method of displaying e-content. The video 1300 is a square frame that contains a screen shot of the video.

Referring to FIG. 14, however, this is an example of a screen shot of the video as in FIG. 13 optimally scaled and cropped using the current invention of displaying e-content. As can be seen, the video screen shot 1400 is scaled up to be larger and it is also cropped at the top and bottom. The resulting video screen shot 1400 is more artistic and draws more attention to the video itself.

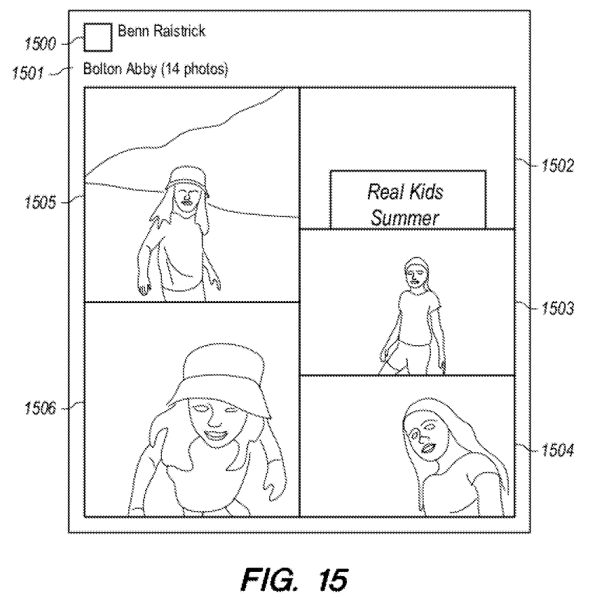

Referring to FIG. 15, this is an example of displaying multiple images and text as presented using the current tiling and stacking method of displaying e-content. The owner 1500 has published a series of photos of another person 1501. A cover consisting of 5 photos displays the series of photos that each fit a frame to form a larger square frame. Specifically the right hand column consists of a title photo 1502 on to top with two photos 1503, 1504 beneath it. The left hand column consists of two larger photos 1505, 1506. The current tiling and stacking method of displaying e-content does not take into account the face and features of the photos and therefore cropped and scaled the photos with the purpose of fitting them into a predetermined frame. Therefore, photos may be cropped in an undesired manner, such as the title photo 1502 where the words are partially cut off.

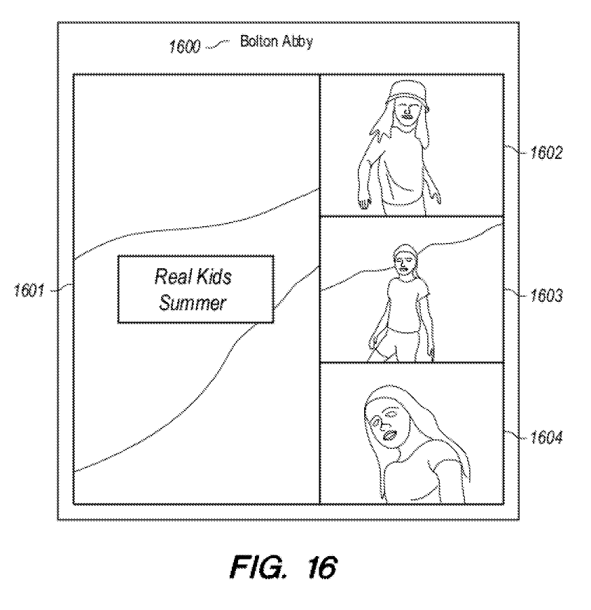

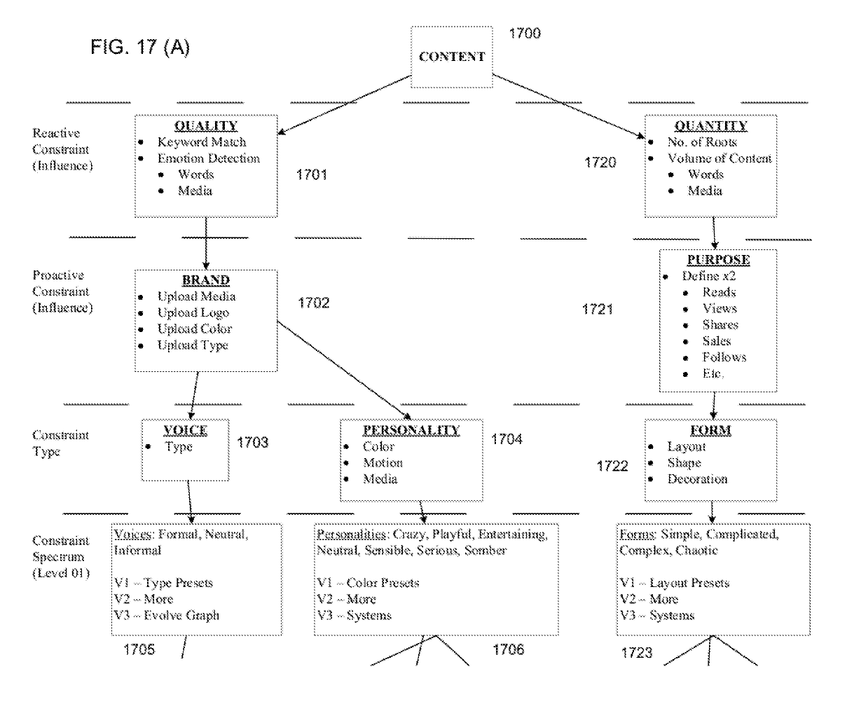

Referring to FIG. 16, this is an example of displaying the multiple images and texts as in FIG. 15 using the method of the current invention of displaying e-content. The method of the current invention provides a large font to identify the subject or person 1600 whose photo was being taken. Then, the current invention performs a detection of important features, such as faces, foreground subjects, and background objects. Then, it determines the title photo 1601 should occupy a larger space on the left hand column, and it selects 3 photos 1602, 1603, 1604 where the subject 1600 is closer in the photo via face and subject detection feature. The 3 photos 1602, 1603 and 1604 are optimally cropped and scaled to fit into the frame.

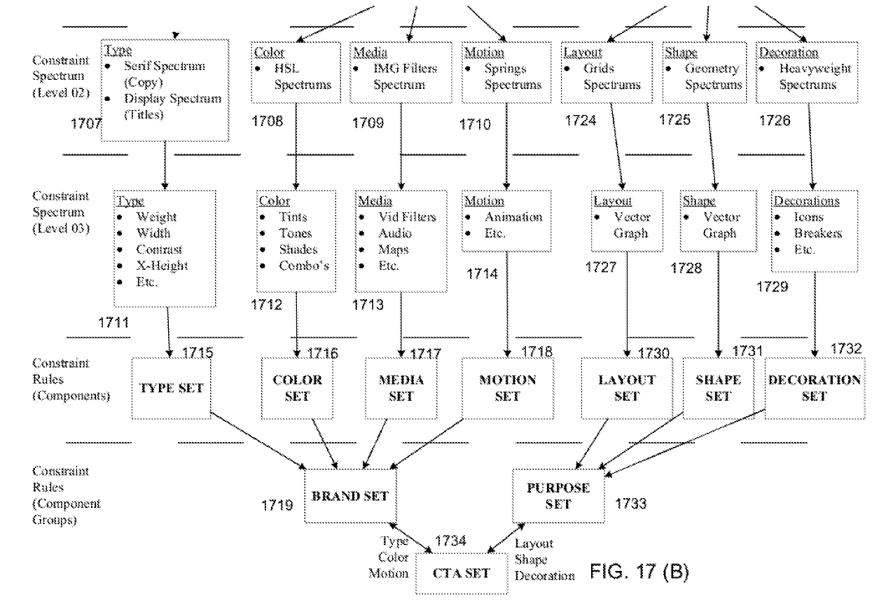

Referring to FIG. 17, this illustrates a preferred embodiment of the present flattening engine that receives and analyzes content 1700 to be published. This engine behaves as a synthesis module comprised of two sub-modules to discern both quality 1701 and quantity 1720 of incoming content 1700 to be published. The quality module 1701 is designed to act as a reactive constraint that will influence the finalized content to be published. The module synthesizes the emotional or expressive substance of the incoming content 1700 by keyword matching and by detecting emotional substance contained in the words and media of the content 1700. The resulting data from the quality module 1701 is then passed to the brand module 1702.

The brand module 1702 influences the final published product by allowing the user to add proactive constraints if they so desire. This module allows a user to upload personal media and logos that they desire the published product to mimic. From these the module extracts color and type font using two sub-modules voice 1703 and personality 1704 to influence the final published product.

As to the first sub-module, voice 1703, this module analyzes text contained in the user-uploaded brand and extracts the uploaded type or font to provide a constraint to be incorporated in the final published product. Once extracted, the data is subjected to three levels of constraint spectrums including 1705, 1707, and 1711. The first 1705 is dictated by user input based on a sliding scale. The user may specify a preference for formal, neutral, or informal voice regarding the font. Based on this input, the sub-module adds a constraint to the data regarding which fonts may be used. The second 1707 similarly apply constraints to the Serif Spectrum and Display Spectrums. The third and final constraint spectrum for type 1711 similarly adds constraints to the weight, width, contrast, X-height, etc. to be used in the font. The result of these three is a Type Set 1715 of constraint rules to dictate the appearance of all text in the final published product and becomes one of four components of the Brand Set 1719.

As to the second sub-module, personality 1704, this module discerns the colors, type of motion, and media contained in the user-uploaded brand and extracts this information as constraints on personality. The personality sub-module 1704 is comprised of three levels of constraint spectrums. The second and third level spectrums each have separate constraints for color, media, and motion. The first 1706 is dictated by user input based on a sliding scale. The user may specify a preference for crazy, playful, entertaining, neutral, sensible, serious, or somber. Based on this input, the sub-module adds a second level of constraints to the data regarding what color, media, and motion specifications may be used. Accordingly, color 1708 is determined using HSL spectrum that best reflects user input in 1706. An HSL color spectrum consists of color, saturation, hue, and lightness. Media 1709 constraints are applied using a spectrum of IMG Filters that best reflects user input in 1706. Motion 1710 constraints are also applied using a spectrum of spring motions that best reflects user input in 1706. A third level of constraint is then added for color, media, and motion. Regarding color 1712, constraints are set forth for tint, tone, shade, etc. and other various combinations. The result is a Color Set 1716 of constraint rules to dictate the appearance of all color in the final published product and becomes one of four components of the Brand Set 1719. For media 1713, constraints are set forth for video filters, audio, maps, etc. The result is a Media Set 1717 of constraint rules to dictate the appearance of all media in the final published product and becomes one of four components of the Brand Set 1719. For motion 1714, constraints are set forth for animation etc. of the future published content. The result is a Motion Set 1717 of constraint rules to dictate the appearance of motion in the final published product and becomes one of four components of the Brand Set 1719. This concludes the description of the quality module 1701.

The quantity module 1720 is designed as a reactive constraint that will influence the finalized content to be published. The module discerns the number of roots in the content 1700. It also discerns the volume of the content 1700 by detecting words and media contained therein. The resulting data from the quantity module 1720 is then passed to the purpose module 1702. The purpose module 1721 influences the final published product by allowing the user to add proactive constraints. This module allows a user to select two goals or purposes they wish the website to accomplish. Pending their selections, this module then instructs the form sub-module 1722 to apply constraints most consistent with those purposes. Accordingly, the form sub-module 1722 then applies constraints to layout, shape, and decoration regarding the content 1700 to be published.

The data is then subjected to three levels of constraint spectrums. The second and third levels are composed of three individual constraint spectrums for layout, shape, and decoration. The first level constraint spectrum 1723 is dictated by user input based on a sliding scale. The user may specify a form preference of simple, complicated, complex, or chaotic. Based on this input, the sub-module adds a second level of constraints to the data regarding what specifications for layout 1724, shape 1725, and decoration 1726 may be used. Accordingly, layout 1724 is constrained using grid spectrums that best reflect user input in 1723. Shape 1725 constraints are applied using geometry spectrums that best reflect user input in 1723. Decoration 1726 constraints are also applied using heavyweight spectrums that best reflect user input in 1723. A third level of constraint is then added for layout 1727, shape 1728, and decorations 1729. Regarding layout 1727, constraints are set forth regarding vector graphics. Vector graphics is a method of electronically coding graphic images so they are represented in lines rather than fixed bitmaps, allowing an image, as on a computer screen, to be rotated or proportionately scaled. The result is a Layout Set 1730 of constraint rules to dictate the layout of the final published product and becomes one of three components of the Purpose Set 1733. For shape 1728, constraints are also set forth regarding vector graphics. The result is a Shape Set 1731 of constraint rules to dictate the shape of the final published product and becomes one of three components of the Purpose Set 1733. For decoration 1732, constraints are also set forth regarding icons, breakers, etc. The result is a Decoration Set 1731 of constraint rules to dictate the decoration of the final published product and becomes one of three components of the Purpose Set 1733. This concludes the description of the quantity module 1720.

The Brand Set 1719 is comprised of the Type Set 1715, Color Set 1716, Media Set 1717, and Motion Set 1718. The Purpose Set 1733 is comprised of the Layout Set 1730, Shape Set 1731, and Decoration Set 1732. Together the Brand Set 1719 and Purpose Set 1733 constitute the finalized CTA Set 1734 of metadata for the content 1700 that is to be published.

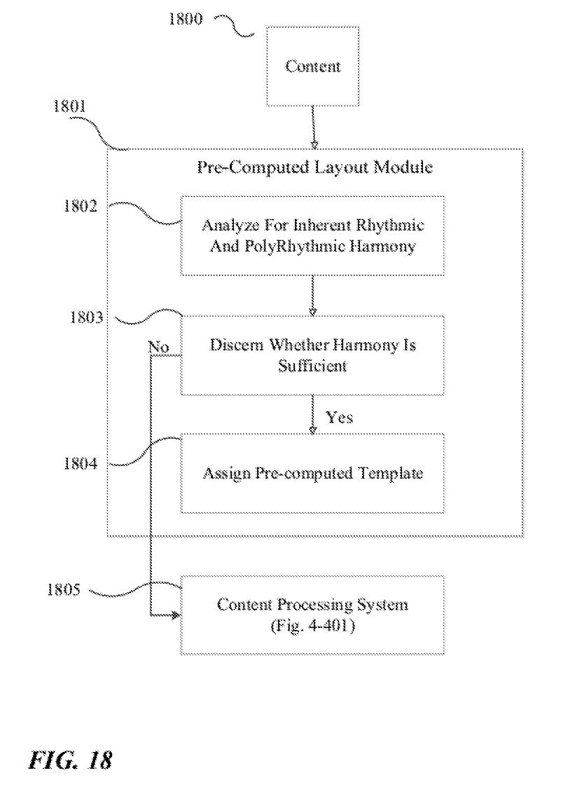

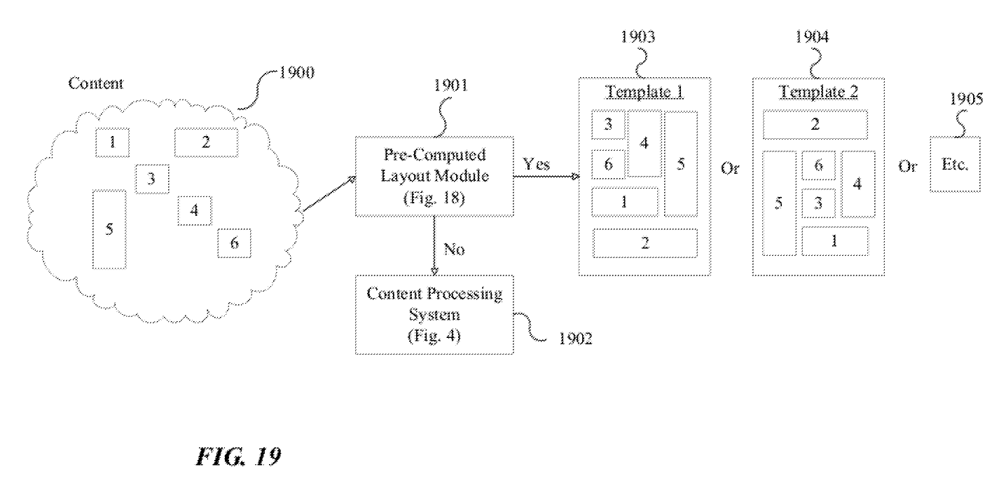

Referring to FIG. 18, this block diagram illustrates a present pre-computed layout module 1801 that receives content 1800 and analyzes it for inherent harmony 1802. Evaluating harmony requires evaluating how well a collection of objects or elements conform to repetitive patterns. Patterns may be rhythmic or polyrhythmic in nature. A rhythmic pattern is a straightforward manifestation of the same pattern in multiple elements. A polyrhythmic pattern is the simultaneous use of two or more conflicting rhythms, which are not readily perceived as deriving from one another, or as straightforward manifestation of the same rhythmic pattern. By combining many such patterns, or harmonies, the harmonic quality of arbitrary metadata may be discerned. To discern the data for patterns, or harmony, a track method monitors for “hits” and “misses” of a particular pattern. Track methods do not score hits and misses but merely compute them. Different track scoring functions subsequently score the results. Assuming a sufficient overall harmony score, the content is then assigned a pre-computed layout, thereby conserving computational resources that would otherwise be consumed by the content processing engine 1805.

The pre-computed layout module 1801 first receives the content to be published 1800. The content is then analyzed for inherent rhythmic and polyrhythmic harmony and is assigned a score 1802. Harmony elements that may be analyzed may include but are not limited to color schemes, color contrast, item size, item shape, media content, media length, text length, text font, text size, etc. By contrasting each element against all others, a harmony score is assigned to each element. This score represents how well that particular element compliments or detracts from all others as a whole. Each individual score is then compiled into an overall harmony score. Next, the module discerns whether the overall harmony score is sufficient enough to be assigned a pre-computed template 1803. If inherent harmony is high, a template is assigned and published 1804 saving significant computational resources. If not so, the content is delivered to the content processing engine (FIG. 4) 1805 for further flattening, enrichment, and subsequent publishing.

Referring to FIG. 19, this diagram is an example of how a pre-computed layout module 1901 might analyze content 1900 with six items possessing inherent harmony and then assign a pre-computed template 1903, 1904, 1905, consequently preserving computational resources by effectively bypassing the content processing system 1902. Content 1900 is first received and analyzed by the pre-computed layout module 1901 as illustrated by FIG. 18. For purposes of this illustration, it is assumed the resulting harmony score is sufficient to bypass the content processing system 1902. Although significantly harmonious, there may be lingering disharmony within the content 1900. As such, each template may be pre-designed to resolve different and various amounts of lingering disharmony. Accordingly, the module 1902 will assign the template 1903, 1904, 1905, that best resolves any lingering disharmony, thus, resulting in a magazine like publication of the content 1900 without consuming precious computational resources by activating the content processing system (FIG. 4) 1902.

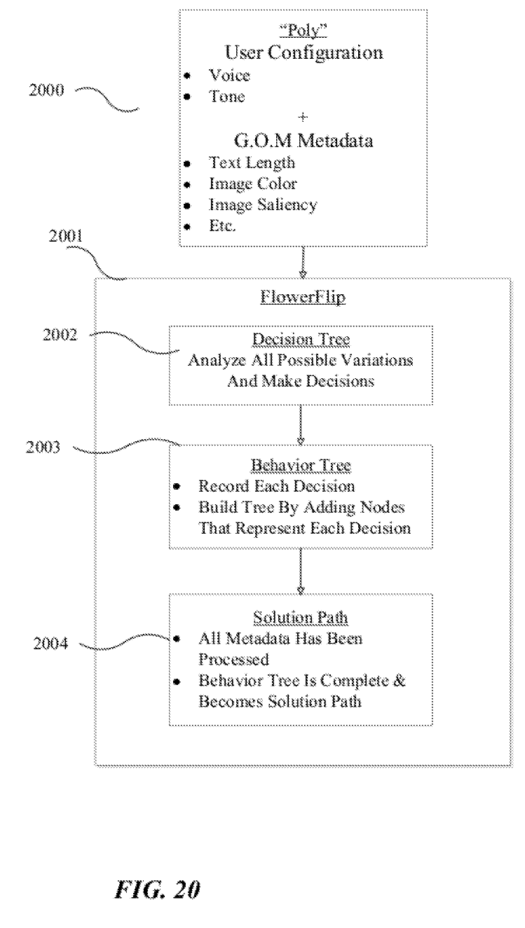

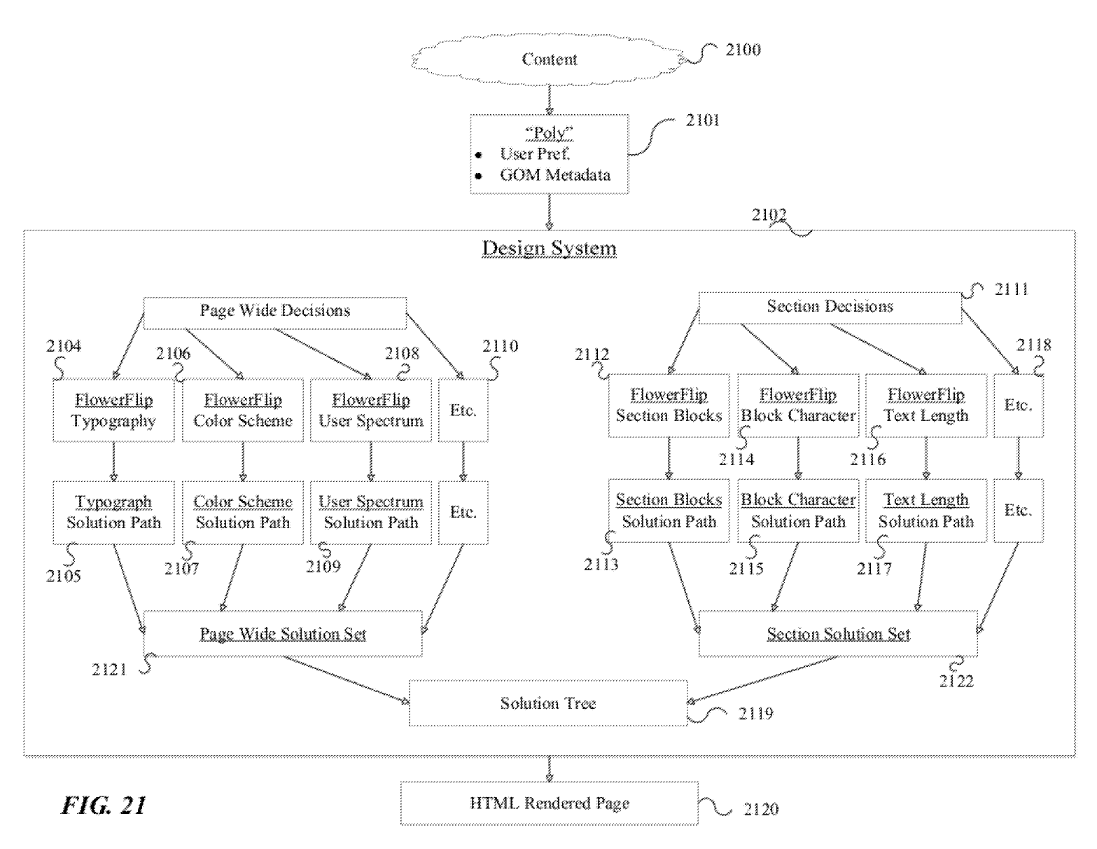

Referring to FIG. 20, this figure illustrates a preferred embodiment of the present solution pathway module 2001 that receives and analyzes user configuration as well as GOM metadata from “Poly” 2000 to form a solution path 2004 to be utilized by the design system in FIG. 21. GOM stands for “generic object model” or is sometimes referred to as “generic data model.” GOM data are binary representations of the relationships each element of the content, such as text length, image color, etc., possess with all other elements. This metadata and user configuration 2000 is delivered to the solution pathway module 2001.

A Solution Pathway Module is an API, or “application programming interface,” that allows the creation of promise-based decision trees. A decision tree 2002 is composed of all possible choices that can be made and also defines how these choices relate to each other. A “promise” is an asynchronous programming method that allows code to listen for a certain condition. Promises are asynchronous because they can run simultaneously with other code in order to monitor or listen. Typical programming must run sequentially, one line after another, or synchronously in other words. The decision tree 2002 in solution pathway module 2001 is composed of promises that are chained together through which metadata 2000 may be processed to discern an optimal solution. As a result, promise based decision trees cannot fail, or return no solution. This is possible because promises, which can run asynchronously, may be told to respond to unfulfilled events or errors by passing the original metadata down the chain instead of halting or failing.

The behavior tree sub-module 2003 supports the promise-based decision tree 2002 and is composed of nodes. When the decision tree 2002 makes a choice (i.e. a promise is fulfilled), the behavior tree 2003 keeps track of each decision by adding a node to represent that decision, thus, building the behavior tree. Decision after decision the behavior tree 2003 will begin to take shape. When the metadata 2000 has been fully processed by the decision tree 2002, the behavior tree 2003 will be complete. The completed behavior tree 2003 will illuminate a pathway of decisions made by the decision tree 2002, which later instructs the design system (FIG. 21). This pathway is known as the solution path 2004.

Referring to FIG. 21, this illustrates an embodiment of a design system 2102 utilizing solution pathway module to produce a solution tree 2119 and consequently an HTML rendered page 2120. Design systems 2102 are used in The Grid as solvers for web page designs as well as HTML and style rendering of the resulting webpage 2120. A Solution Pathway Module (FIG. 20-2001) is the API (Application Programming Interface) that allows the creation of design systems 2102. A central part of a design system 2102 is the decision tree used to make all the design decisions needed to create a web page. The illustrated design system 2102 is designed to make decisions in two main categories: page wide decisions 2103, and section decisions 2111.

Page wide decisions 2103 include but are not limited to typography 2104, color scheme 2106, and user spectrum 2108. Each page wide decision utilizes solution pathway modules (FIG. 20-2001) to produce a solution path such as typography solution path 2105, color scheme solution path 2107, and user spectrum solution path 2109. These and other solution paths 2110, constitute the page wide solution set 2121. Section decisions 2111 include but are not limited to section block 2112, block character 2114, and text length 2116. Each section decision uses solution pathway modules (FIG. 20-2001) to produce a solution path such as section block solution path 2113, block character solution path 2115, and text length solution path 2117. These and other solution paths 2118, constitute the section solution set 2122. Together, the page wide solution set 2121 and the section solution set 2122 comprises the final solution tree 2119. Having completed the solution tree 2119 it is now possible to render a fully published, magazine quality, HTML webpage.

1. A computer-implemented system, comprising: a content flattening engine, which in operation, accepts a plurality of content from a dynamically aggregated feed of content or from an user input; parses and dissects said content into units of text and or media file and recording a plurality of attributes and properties of said units; categorizes said units based on said attributes and said properties; a content enrichment engine, which in operation, enriches said units according to said attributes and said properties by reformatting and resizing said units into a plurality of processed units for optimization of harmonious fitment and displaying performance of a layout; a layout engine, which in operation, accepts said processed units and matching said processed units to said layout wherein said layout is selected from a repository of layout templates; a presentation engine, which in operation, integrates said processed units into a designated position of said layout; requests said enrichment engine to further reformat said processed units in order to snug fit said processed units into said layout resulting a final ready layout; presents said final ready layout; wherein said flattening engine in operation behaves as a synthesis module to discern quality and quantity of said content and is comprised of a quality module and a quantity module where in operation said quality module in operation synthesizes the emotional and expressive substance of said content and said quantity module in operation synthesizes the number of roots in said content and discerns volume of said content.

2. The claim of 1 wherein said quality module in operation synthesizes the emotional and expressive substance of said content by keyword matching to detect emotional substance contained in the words and media of the content.

3. The claim of 1 wherein said quantity module in operation discerns volume of said content by detecting words and media contained therein.

4. The claim of 1 wherein said quality module is further comprised of a brand module where in operation said brand module allows an user to upload one or plurality of media or logo.

5. The claim of 4 wherein said quality module is further comprised of a voice module and a personality module where in operation said voice module analyzes text of said uploaded media or logo or said content to provide a voice constraint and said personality module discerns colors, motions and media contained of said uploaded media or said content to provide a personality constraint.

6. The claim of 5 wherein said voice module is further comprised of a first submodule wherein said first submodule in operation categorizes the content are either formal, neutral or informal or allows user to request the content to be either formal, neutral or informal.

7. The claim of 5 wherein said voice module is further comprised of a second submodule wherein said second submodule in operation analyzes said content using Serif Spectrum and Display Spectrum or allow the user request the content constraint using Serif Spectrum and Display Spectrum.

8. The claim of 5 wherein said voice module is further comprised of a third submodule wherein said third submodule in operation analyzes said content's font to discern the font's weight, width, contrast and height of said font or allow the user to request content constraint using font's weight, width, contrast and height.

9. The claim of 5 wherein said personality module is further comprised of a first submodule wherein said first submodule in operation categorizes said content as crazy, playful, entertaining, neutral, sensible, serious, or somber or allow the user to request the content constraint to be either crazy, playful, entertaining, neutral, sensible, serious, or somber.

10. The claim of 5 wherein said personality module is further comprised of a color submodule wherein said color submodule in operation discerns color using HSL Spectrum or allow the user to request the content constraint using HSL Spectrum.

11. The claim of 5 wherein said personality module is further comprised of a media submodule wherein said media submodule in operation discerns media using image filter spectrum allow the user to request the content constraint using image filter spectrum.

12. The claim of 5 wherein said personality module is further comprised of a motion submodule wherein said motion submodule in operation discerns motions using Springs Spectrum or allow the user to request the content constraint using Spring Spectrum.

13. The claim of 10 wherein said color submodule in operation discerns tints, tones, shades and combination of tints and tones and shades or allow the user to request the content constraint as to tints, tones, shades and combination of tints and tones and shades.

14. The claim of 11 wherein said media submodule in operation discerns audio file, maps and videos or allow the user to request the content constraint as to audio file, maps and videos.

15. The claim of 1 wherein said quantity module is comprised of a purpose module wherein in operation it discerns the content for purpose or allow the user to request the content constraint as to purpose.

16. The claim of 15 wherein said purpose is selected from a group consisting of reads, views, shares, sales and follows.

17. The claim of 15 wherein said purpose module is comprised of a form module where in operation the form module discerns the content and categorize the form to be either simple, complicated, complex or chaotic or allow the user to selected the forms to be either simple, complicated, complex or chaotic.

18. The claims of 17 wherein said form module is further comprised of a layout module where in operation the module discerns the content using a Grid Spectrum or allow the user to request content constraint by using a Grid Spectrum.

19. The claims of 17 wherein said form module is further comprised of a shape module where in operation the module discerns the content using a Geometry Spectrum or allow the user to request content constraint by using a Geometry Spectrum.

20. The claims of 17 wherein said form module is further comprised of a shape module where in operation the module discerns the content using a Geometry Spectrum or allow the user to request content constraint by using a Geometry Spectrum.

21. The claims of 17 wherein said form module is further comprised of a decoration module where in operation the module discerns the content using a Heavyweight Spectrum or allow the user to request content constraint by using a Heavyweight Spectrum.

22. The claim of 18 where in operation the layout module utilizes vector graphics.

23. The claim of 19 where in operation the layout module utilizes vector graphics.
